(19) United States
(12) Patent Application Publication
(10) Pub. No.: US 2025/0265331 A1
(43) Pub. Date: Aug. 21, 2025

(54) SYSTEM AND METHOD FOR INTEGRATIVE MONITORING OF ENTERPRISE APPLICATIONS AND DETECTION OF INCREASED DATA EXPOSURE

(71) Applicant: BANK OF AMERICA CORPORATION, Charlotte, NC (US)

(72) Inventors: Conor Mitchell Liam Nodzak, Charlotte, NC (US); Ravindra Bandaru, Charlotte, NC (US); Brian C. Busch, Charlotte, NC (US); Girish Nanjappa Lingappa, Buffalo Grove, IL (US); Kyle S. Sorensen, Highlands Ranch, CO (US); Shreyas Srinivas, Charlotte, NC (US)

(73) Assignee: BANK OF AMERICA CORPORATION, Charlotte, NC (US)

(21) Appl. No.: 18/581,787

(22) Filed: Feb. 20, 2024

(51) Int. Cl. G06F 21/55; G06F 21/64

(52) U.S. Cl. CPC G06F 21/552; G06F 21/64; G06F 2221/033

(57) ABSTRACT

Systems, computer program products, and methods are described herein for integrative monitoring of enterprise applications and detection of increased data exposure. The present disclosure is configured to monitor, via a machine learning model (MLM), a set of data resiliency exposure indicators (DREI) within a plurality of enterprise applications, a temporal graph associated with the set of DREI, and a set of enterprise application measurement data, for data exposure within the plurality; perform temporal graph analysis of the temporal graph associated with the DREI via the MLM; detect increases in data exposure within the set of DREI, the temporal graph associated with the set of DREI, and the set of enterprise application measurement data via the MLM, where detecting increases in data exposure within the set of DREI are found within relationships between components of the set of DREI; and map changes of increases within the plurality of enterprise applications.

### TECHNOLOGICAL FIELD

Example embodiments of the present disclosure relate to integrative monitoring of enterprise application and detection of increased data exposure.

### BACKGROUND

With an evolving technical landscape, data exposure within enterprise applications may have increased in complexity and scale. Protecting an enterprise application against data exposures may maintain enterprise operations and security.

Applicant has identified a number of deficiencies and problems associated with integrative monitoring of enterprise applications and detection of increased data exposure. Through applied effort, ingenuity, and innovation, many of these identified problems have been solved by developing solutions that are included in embodiments of the present disclosure, many examples of which are described in detail herein.

### BRIEF SUMMARY

Systems, methods, and computer program products are provided for integrative monitoring of enterprise applications and detecting increased data exposure.

In one aspect, a system for integrative monitoring of enterprise applications and detection of increased data exposure is presented. The system comprising a processing device, at least one non-transitory storage device, and at least one processing device coupled to the at least one non-transitory storage device wherein the at least one processing device is configured to: monitor, via a machine learning model (MLM), a set of data resiliency exposure indicators (DREI) within a plurality of enterprise applications, a temporal graph associated with the set of DREI, and a set of enterprise application measurement data, for data exposure within the plurality of enterprise applications; perform temporal graph analysis of the temporal graph associated with the set of DREI via the MLM; detect increases in data exposure within the set of DREI, the temporal graph associated with the set of DREI, and the set of enterprise application measurement data via the MLM, wherein detecting increases in data exposure within the set of DREI are found within relationships between components of the set of DREI; and map changes of increases in data exposure within the plurality of enterprise applications.

In some embodiments, the at least one processing device is further configured to predict potential data exposure within the plurality of enterprise applications via event-based clustering, wherein event-based clustering highlights potential data exposure.

In some embodiments, wherein the set of DREI comprises a set of time stamps.

In some embodiments, wherein the set of DREI within the plurality of enterprise applications is updated in predetermined intervals.

In some embodiments, wherein mapping changes in increase in data exposure in the set of DREI further comprises highlighting components of the set of DREI associated with increased data exposure.

In some embodiments, wherein the temporal graph associated with the set of DREI may comprise telemetry data and metadata associated with the plurality of enterprise applications metadata.

In some embodiments, wherein the set of DREI comprises a set of infrastructure, enterprise application processes, service metrics, and enterprise application data.

In another aspect, a computer program product for integrative monitoring of enterprise application and detection of increased data exposure is presented. The computer program product comprising at least one non-transitory computer-readable medium having computer-readable program code portions embodied therein, the computer-readable program code portions which when executed by a processing device are configured to cause the processor to perform the following operations: monitor, via a machine learning model (MLM), a set of data resiliency exposure indicators (DREI) within a plurality of enterprise applications, a temporal graph associated with the set of DREI, and a set of enterprise application measurement data, for data exposure within the plurality of enterprise applications; perform temporal graph analysis of the temporal graph associated with the set of DREI via the MLM; detect increases in data exposure within the set of DREI, the temporal graph associated with the set of DREI, and the set of enterprise application measurement data via the MLM, wherein detecting increases in data exposure within the set of DREI are found within relationships between components of the set of DREI; and map changes of increases in data exposure within the plurality of enterprise applications.

In some embodiments the processor is further configured to predict potential data exposure via event-based clustering, wherein event-based clustering highlights potential data exposure.

In some embodiments, the set of DREI comprises a set of time stamps.

In some embodiments, the set of DREI within the plurality of enterprise applications is updated in predetermined intervals.

In some embodiments, mapping changes in increase in data exposure in the set of DREI further comprises highlighting components of the set of DREI associated with increased data exposure.

In some embodiments, the temporal graph associated with the set of DREI may comprise telemetry data and metadata associated with the plurality of enterprise applications metadata.

In some embodiments, the set of DREI comprises a set of infrastructure, enterprise application processes, service metrics, and enterprise application data.

In another aspect, a computer implemented method for integrative monitoring of enterprise applications and detection of increased data exposure is presented. The computer-implemented method may comprise: monitoring, via a machine learning model (MLM), a set of data resiliency exposure indicators (DREI) within a plurality of enterprise applications, a temporal graph associated with the set of DREI, and a set of enterprise application measurement data, for data exposure within the plurality of enterprise applications; performing temporal graph analysis of the temporal graph associated with the DREI via the MLM; detecting increases in data exposure within the set of DREI, the temporal graph associated with the set of DREI, and the set of enterprise application measurement data via the MLM, wherein detecting increases in data exposure within the set of DREI are found within relationships between components of the set of DREI; and mapping changes of increases in data exposure within the plurality of enterprise applications.

In some embodiments, the method further comprises predicting potential data exposure via event-based clustering, wherein event-based clustering highlights potential data exposure.

In some embodiments, the set of DREI comprises a set of time stamps.

In some embodiments, the set of DREI within the plurality of enterprise applications is updated in predetermined intervals.

In some embodiments, mapping changes in increase in data exposure in the set of DREI further comprises highlighting components of the set of DREI associated with increased data exposure.

In some embodiments, the set of DREI comprises a set of infrastructure, enterprise application processes, service metrics, and enterprise application data.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for integrative monitoring of enterprise applications and detection of increased data exposure, in accordance with an embodiment of the disclosure.

FIG. 2 illustrates an exemplary machine learning (ML) subsystem architecture in accordance with an embodiment of the disclosure; and

FIG. 3 illustrates a process flow for integrative monitoring of enterprise applications and detection of increased data exposure, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As enterprises expand in complexity and technology, security and potential exposure of enterprise application data may alter operations and capabilities of an enterprise. Further, with an increasingly interconnected and technical landscape, detecting data exposure within elements of an enterprise application and relationships between elements may significantly increase in difficulty. With the advancement of machine learning however, monitoring data exposure within enterprise applications may be conducted with a more integrative approach.

While telemetry data and application metrics may be used to evaluate data exposure, these measurements provide isolated and limited insights into data exposure of an enterprise application. Understanding the complicated relationship and functions from telemetry data and application metrics alone may result in undiagnosed data exposure, or untimely efforts to mitigate potential data exposure. An integrative analysis of the enterprise applications and the components within the enterprise applications that increase data exposure may drastically reduce data exposure and further promote data security.

Enterprise applications may be analyzed using machine learning models to detect and predict data exposure within components of enterprise applications and relationships between components. Data resiliency exposure indicators (DREI), temporal graph analysis, and enterprise application measurement data (e.g., telemetry) within enterprise applications may be monitored and analyzed by the MLM. Integrative monitoring of the plurality of enterprise applications provides comprehensive knowledge of data exposures and may enable counter measures to prevent and mitigate data exposure. Further, knowledge of the affected components from increased data exposure may minimize future exposure of data within the enterprise from potential malicious actors.

Accordingly, the present disclosure monitors a set of data resiliency exposure indicators (DREI) within a plurality of enterprise applications, a temporal graph associated with the set of DREI, and a set of enterprise application measurement data for data exposure using machine learning models (MLM). Temporal graph analysis may be performed on the temporal graph via the MLM. Increases in data exposure may then be detected by the MLM within the set of DREI, the temporal graph analysis of the temporal graph associated with the set of DREI, and the set of enterprise application measurement data. Increased data exposure may further be found in relationships between components of the set of DREI. Increases in data exposure within the plurality of enterprise applications may then be mapped to highlight sources of data exposure.

What is more, the present disclosure provides a technical solution to a technical problem. As described herein, the technical problem includes detecting data exposure within enterprise applications. The technical solution presented herein allows for detecting data exposure within enterprise applications. In particular, integrative monitoring of enterprise applications to detect increased data exposure is an improvement over existing solutions to detecting data exposure, (i) with fewer steps to achieve the solution, thus reducing the amount of computing resources, such as processing resources, storage resources, network resources, and/or the like, that are being used, (ii) providing a more accurate solution to problem, thus reducing the number of resources required to remedy any errors made due to a less accurate solution, (iii) removing manual input and waste from the implementation of the solution, thus improving speed and efficiency of the process and conserving computing resources, (iv) determining an optimal amount of resources that need to be used to implement the solution, thus reducing network traffic and load on existing computing resources. Furthermore, the technical solution described herein uses a rigorous, computerized process to perform specific tasks and/or activities that were not previously performed. In specific implementations, the technical solution bypasses a series of steps previously implemented, thus further conserving computing resources.

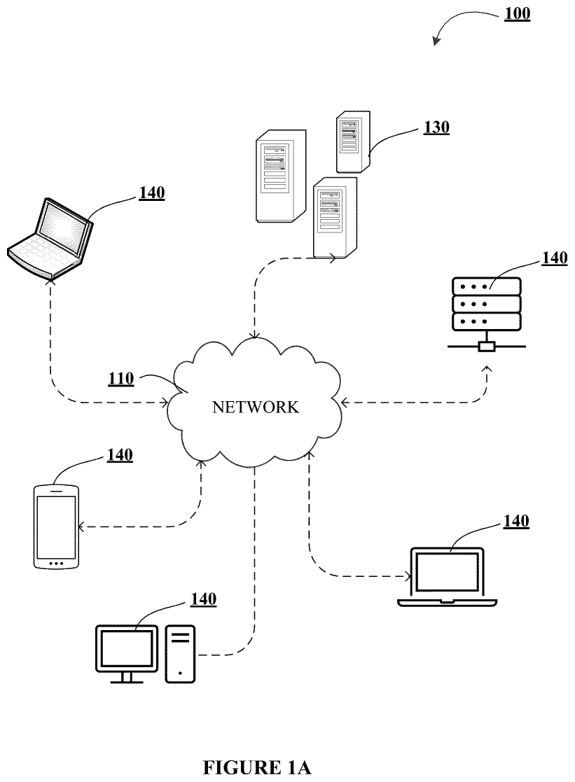

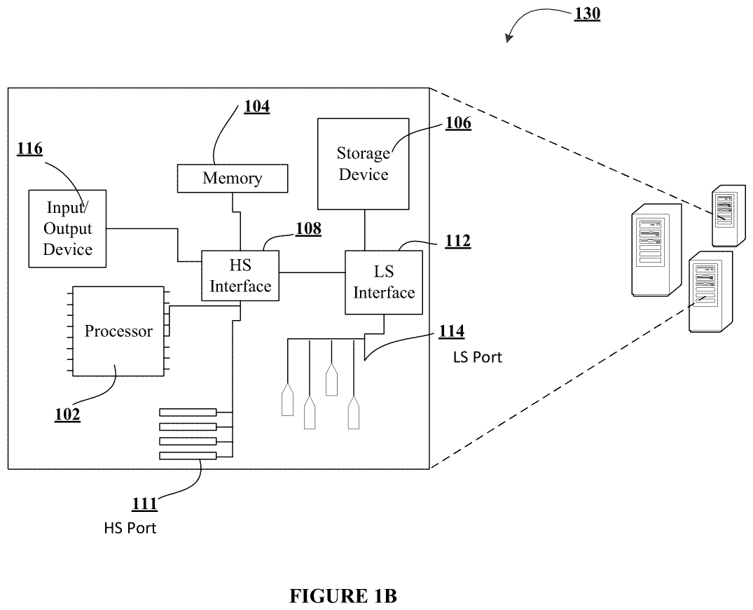

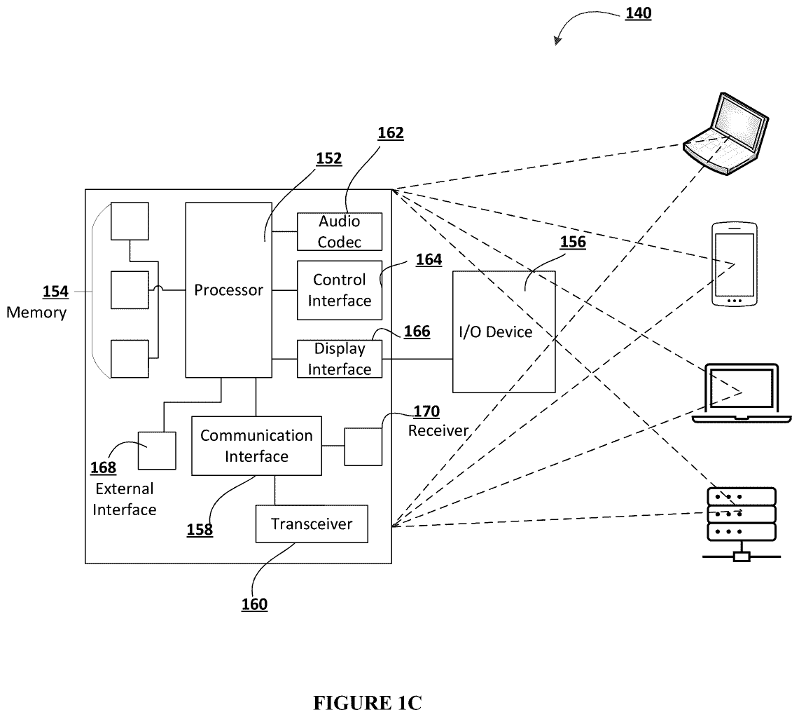

FIGS. 1A-1C illustrate technical components of an exemplary distributed computing environment for integrative monitoring of enterprise applications and detection of increased data exposure 100, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation- and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

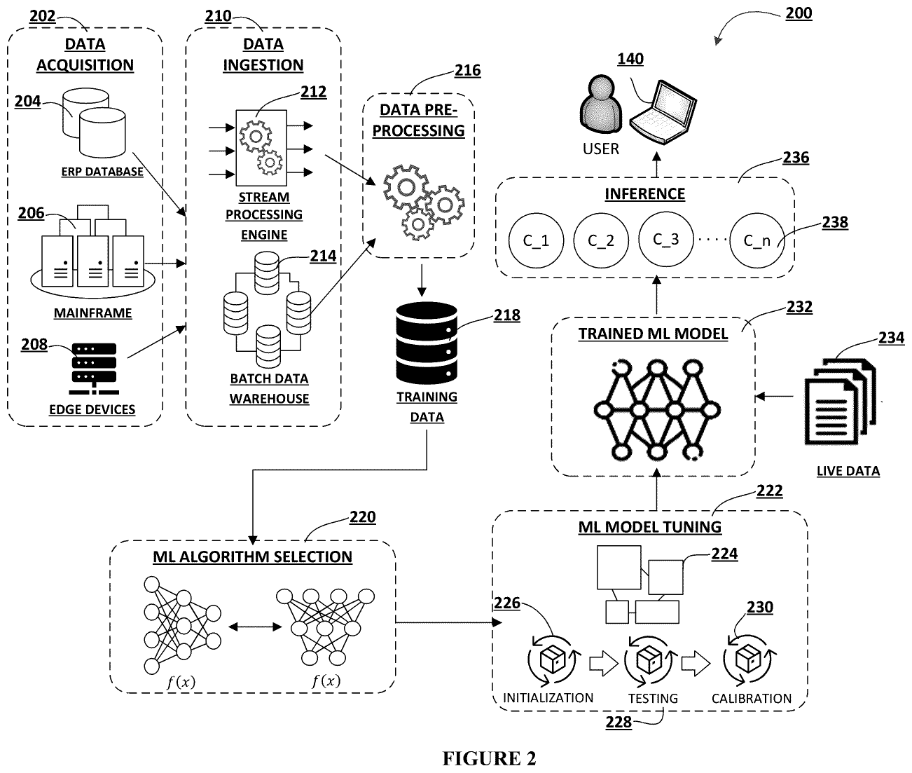

FIG. 2 illustrates an exemplary machine learning (ML) subsystem architecture 200, in accordance with an embodiment of the invention. The machine learning subsystem 200 may include a data acquisition engine 202, data ingestion engine 210, data pre-processing engine 216, ML model tuning engine 222, and inference engine 236.

The data acquisition engine 202 may identify various internal and/or external data sources to generate, test, and/or integrate new features for training the machine learning model 224. These internal and/or external data sources 204, 206, and 208 may be initial locations where the data originates or where physical information is first digitized. The data acquisition engine 202 may identify the location of the data and describe connection characteristics for access and retrieval of data. In some embodiments, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 204, 206, and 208 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 202, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In machine learning, the quality of data and the useful information that can be derived therefrom directly affects the ability of the machine learning model 224 to learn. The data pre-processing engine 216 may implement advanced integration and processing steps needed to prepare the data for machine learning execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and/or combine variables into features, effectively reducing the amount of data that must be processed, while still accurately and completely describing the original data set. Depending on the type of machine learning algorithm being used, this training data 218 may require further enrichment. For example, in supervised learning, the training data is enriched using one or more meaningful and informative labels to provide context so a machine learning model can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The ML model tuning engine 222 may be used to train a machine learning model 224 using the training data 218 to make predictions or decisions without explicitly being programmed to do so. The machine learning model 224 represents what was learned by the selected machine learning algorithm 220 and represents the rules, numbers, and any other algorithm-specific data structures required for classification. Selecting the right machine learning algorithm may depend on a number of different factors, such as the problem statement and the kind of output needed, type and size of the data, the available computational time, number of features and observations in the data, and/or the like. Machine learning algorithms may refer to programs (math and logic) that are configured to self-adjust and perform better as they are exposed to more data. To this extent, machine learning algorithms are capable of adjusting their own parameters, given feedback on previous performance in making prediction about a dataset.

The machine learning algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

To tune the machine learning model, the ML model tuning engine 222 may repeatedly execute cycles of experimentation 226, testing 228, and tuning 230 to optimize the performance of the machine learning algorithm 220 and refine the results in preparation for deployment of those results for consumption or decision making. To this end, the ML model tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 218. A fully trained machine learning model 232 is one whose hyperparameters are tuned and model accuracy maximized.

The trained machine learning model 232, similar to any other software application output, can be persisted to storage, file, memory, or application, or looped back into the processing component to be reprocessed. More often, the trained machine learning model 232 is deployed into an existing production environment to make practical business decisions based on live data 234. To this end, the machine learning subsystem 200 uses the inference engine 236 to make such decisions. The type of decision-making may depend upon the type of machine learning algorithm used. For example, machine learning models trained using supervised learning algorithms may be used to structure computations in terms of categorized outputs (e.g., C_1, C_2 . . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, machine learning models trained using unsupervised learning algorithms may be used to group (e.g., C_1, C_2 . . . . C_n 238) live data 234 based on how similar they are to one another to solve exploratory challenges where little is known about the data, provide a description or label (e.g., C_1, C_2 . . . . C_n 238) to live data 234, such as in classification, and/or the like. These categorized outputs, groups (clusters), or labels are then presented to the user input system 130. In still other cases, machine learning models that perform regression techniques may use live data 234 to predict or forecast continuous outcomes.

It will be understood that the embodiment of the machine learning subsystem 200 illustrated in FIG. 2 is exemplary and that other embodiments may vary. As another example, in some embodiments, the machine learning subsystem 200 may include more, fewer, or different components.

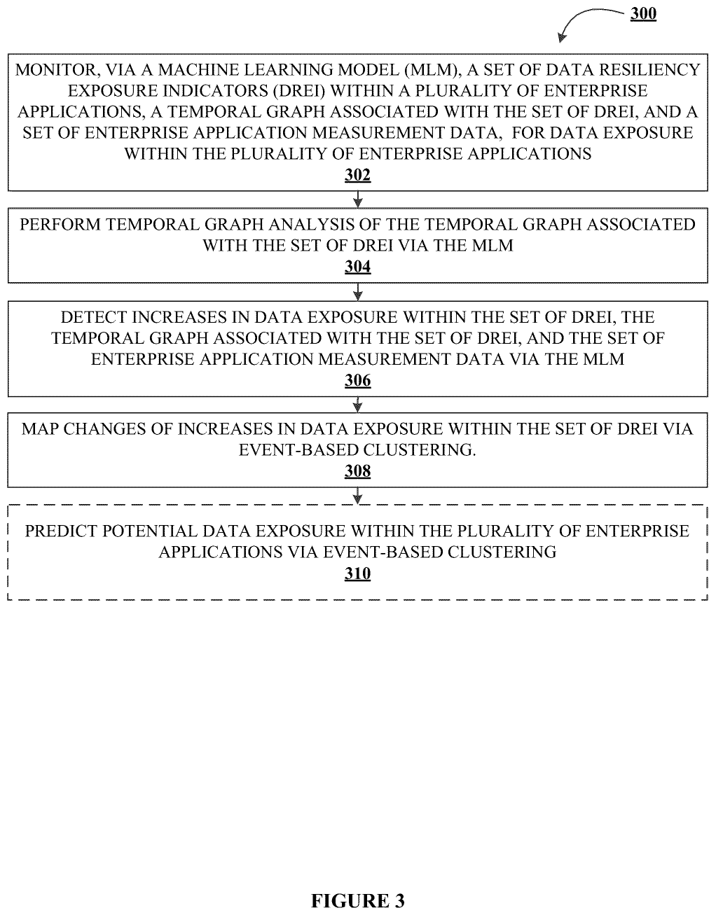

FIG. 3 illustrates a process flow for integrative monitoring of enterprise applications and detecting increased data exposure. As shown in Block 302, the process flow includes monitoring a set of data resiliency exposure indicators (DREI) within a plurality of enterprise applications, a temporal graph associated with the set of DREI, and a set of enterprise application measurement data via a machine learning model (MLM) for data exposure.

In some embodiments, the set of DREI may be comprised of a set of infrastructure (e.g., backup health, application access), enterprise application processes (e.g., cross border data movement, inter-application data movement, and/or memory utilization), service metrics (e.g., network volume, network traffic quality, centralized processing unit (CPU) performance, disk performance, and/or disk usage), and enterprise application data (e.g., data dependability, job queues, etc.). The set of DREI may indicate increased data exposure within the plurality of enterprise application (e.g., components within the plurality of enterprise applications) and may be monitored, assessed, and/or evaluated for increases in data exposure. For instance, backup health data within the set of infrastructure of the plurality of enterprise applications may be monitored for adherence to a backup policy, size of a backup, backup status, and abnormal behavior/performance differentiating from average or established behavior associated with the backup. In another instance of monitoring the set of infrastructure, increases or decreases in application access activities (internally and externally) or deviation from average activity may constitute abnormal behavior, thus indicating a higher degree of data exposure.

Indicators of increased data exposure through enterprise application processes within the set of DREI may additionally be monitored. For instance, cross border data movement may indicate an increase in data exposure if unexpected or new cross border data movements are detected within the plurality of enterprise applications. In another instance, inter-application data movement may be monitored for invalid or unauthorized movements indicating increased data exposure within the plurality of enterprise applications. Memory utilization may also indicate increased data exposure, as deviations from average memory utilization (e.g., low or high memory utilization) may be detected within the plurality of enterprise applications.

Increased data exposure through service metrics within the set of DREI may additionally be monitored. For instance, changes in network volume (greater than expected or less than expected network volumes) may indicate increased data exposure from irregular data flows. Network traffic quality (e.g., incoming/outgoing data transfer rates) changes deviating from average or expected quality may additionally indicate increased data exposure. CPU performance (e.g., percentage of the CPU utilized within the plurality of enterprise applications) may indicate increased data exposure. Disk performance within the plurality of enterprise applications may be monitored for changes in a reading and/or writing rate, as well as service time to detect increased data exposure. Disk usage may be monitored, changes in storage percentage, free space changes, and/or disk space variance may indicate an increase in data exposure.

Increased data exposure through enterprise application data may indicate an increase in data exposure. For instance, data dependability within the plurality of enterprise applications may indicate increased data exposure through factors including but not limited to changes in incident tickets, increases or decreases in the number of incidents, and/or changes in the size and/or scope of incidents. In another instance, enterprise application data in the form of deviation from expected job queues may indicate increased data exposure.

In some embodiments, the plurality of enterprise applications may refer to systems, applications, and/or software configured to perform functions associated with operations of an entity. The plurality of enterprise applications may comprise metadata associated with the plurality of enterprise applications and/or subsequent functions of the plurality. Enterprise applications may be measured/provide data, which may be time-stamped and utilized in a temporal graph as described in greater detail below. In some embodiments, enterprise applications may refer to software and systems configured to streamline, support, and/or process functions within an entity. For instance, an enterprise application may be an application or software that organizes, manipulates, controls, and/or operates operations and procedures within an entity and may be monitored for DREI. In some embodiments, the plurality of enterprise applications may be at least one enterprise application.

In some embodiments the temporal graph associated with the set of DREI may comprise network telemetry data and metadata associated with the plurality of enterprise application. Temporal graph analyses may identify evolutionary patterns, identify and track nodes at time points, highlight nodes associated with the set of DREI, detect anomalies, predict relationships or changes based on historical data, as described in greater detail below. The temporal graph may be analyzed using temporal graph analyses to detect and determine the extent of data exposure, as described in greater detail below.

Monitoring the set of DREI within the plurality of enterprise applications may be conducted using a machine learning model (MLM). The MLM may monitor the DREI for deviations, differences, abnormalities, from established procedure associated with the set of enterprise applications. In some embodiments, the MLM may be at least partially based on the machine learning subsystem 200 as seen in FIG. 2. The machine learning subsystem 200 may have aspects or pieces utilized by the MLM described herein. The MLM may be at least partially comprised of components, parts, and/or technologies described in the machine learning subsystem 200 described in FIG. 2. Embodiments of the MLM may interactively monitor the set of DREI within a plurality of enterprise applications, a temporal graph associated with the set of DREI, and a set of enterprise application measurement data.

In some embodiments, the set of DREI may be updated (e.g., the set of infrastructure, process, service metrics, and data within the set of DREI) in periodic intervals and/or received notification. For instance, the set of DREI may be updated/changed after a predetermined length of time to reflect the data exposure associated with the plurality of enterprise applications. In another instance, a notification may be received causing the DREI to be updated (e.g., a change has occurred within the set of DREI that may alter the data expo sure of the plurality of enterprise applications). In some embodiments, the set of DREI may be updated periodically and upon reception of a notification/trigger indicating changes to the set of DREI.

In some embodiments, the set of enterprise application measurement data may include but may not be limited to performance measurements, statistics, metadata, and status measurements associated with the plurality of enterprise applications. The set of enterprise application measurement data may indicate the condition of an enterprise applications within the plurality. For instance, the set of enterprise application measurement data may be analyzed with the set of DREI to determine the data exposure associated with the plurality of enterprise applications. Sources from which the set of enterprise application measurement data may include network telemetry data, network data (and transfers of data within a network), mapping data between infrastructure and apps, metadata on enterprise applications, grouping of services, self-reported data flows, change requests and incident data, information on data incidents, test results, backup server metadata, logs of backup activity, and additional metadata within databases.

As shown in Block 304, the process flow 300 may include performing temporal graph analysis of the temporal graph associated with the DREI via the MLM. For instance, the temporal graph analysis may be conducted and asses the set of DREI through the temporal graph within the plurality of enterprise applications to measure data exposure within the plurality. Data exposure may indicate insecure, faulty, corrupted, and/or compromised data within the enterprise application. Data exposure measured within the set of DREI via the MLM may highlight components, areas, processes, and functions associated with the plurality of enterprise applications. Temporal graph analysis of the temporal graph may be conducted using the MLM to analyze/identify patterns and changes within the set of DREI. Metrics of the temporal graph may be analyzed to predict increased data exposure, the metrics of the temporal graph may include but may not be limited to temporal density, temporal degree centrality, and a temporal clustering coefficient. Community detection algorithms, event detection, visualization, predictive modeling, hypothesis testing, and temporal path analysis may be conducted during the temporal graph analysis to detect increased data exposure within the plurality of enterprise applications.

As shown in Block 306, the process flow 300 may include detecting increases in data exposure within the set of DREI, the temporal graph associated with the set of DREI, and the set of enterprise application measurement data via the MLM. Data exposure associated with the plurality of enterprise applications may have an estimated, average, calculated and/or established level of data exposure. Increases of data exposure above the established level of data exposure may be detected via the MLM. Increases in data exposure may be detected within components of the DREI and relationships between components of the set of DREI. Increases in data exposure may be determined based on the set of DREI, configuration of the MLM, the analyzed temporal graph, and the set of enterprise application data. For instance, the MLM may detect an increase in data exposure within the application processes from the set of DREI. Cross border movement changes may be projected to cause increased data exposure and may affect memory utilization associated with the plurality of enterprise applications. The increase in data exposure may be detected by the MLM, the temporal graph analysis may highlight the relationship between cross border movement and memory utilization within the plurality of enterprise applications, and the set of enterprise application measurement data may indicate an estimation of the data exposure.

As shown in Block 308, the process flow 300 may include mapping changes of increases in data exposure within the plurality of enterprise applications. Increases in data exposure of the plurality of enterprise applications may be mapped to highlight relationships between components of the plurality and the set of DREI. In some embodiments, mapping increases in data exposure may be mapped within a data storage center and/or transmitted as a notification to a predetermined destination. Mapping data exposure may identify components within the plurality of enterprise applications, their relationships to other components, and the level of data exposure identified. Event-based clustering may be conducted to further highlight relationships and connections between components of the set of DREI.

In some embodiments, event-based clustering may refer to grouping and/or categorizing data based on events and/or occurrences. Event-based clustering may be used to identify patterns and/or clusters based on discrete events or occurrences. For instance, events indicating increased data exposure (e.g., changes in data dependability within the plurality of enterprise applications) may be associated with additional DREI (e.g., changes in data dependability may be associated with changes in CPU utilization), which may further cause data exposure.

In some embodiments, as shown in Block 310, the process flow 300 may include predicting potential data exposure via event-based clustering. Event-based clustering may be conducted via the MLM to highlight potential data exposure within the plurality of enterprise applications. The MLM may use event-based clustering to predict groups/clusters of the DREI that may increase data exposure for certain actions associated with the operation of the plurality of enterprise applications. For instance, an event associated with the plurality of enterprise applications may create increased data exposure for the set of infrastructure and cause abnormal behavior in terms of network traffic quality. The MLM may predict potential data exposure for the set of infrastructure and network traffic quality within the plurality of enterprise applications if the event occurs in the future.

In some embodiments, the set of DREI comprises a set of time stamps. The set of time stamps may be referenced in the temporal graph and in the temporal graph analysis. In some embodiments, the set of time stamps may provide snapshots of data flow within the plurality of enterprise applications, which may be used in conjunction with the set of DREI to highlight connections within the enterprise applications. In another instance, the time stamps may be used in the construction of the temporal graph to evaluate relationships between components of the plurality of enterprise applications based on time-based data.

In some embodiments, the set of DREI within the plurality of enterprise applications is updated in predetermined intervals. For instance, the set of DREI may be updated on a monthly, daily, or hourly basis. Time stamps associated with the set of DREI may be analyzed to determine relationships between components of the plurality of enterprise applications and compared to an updated set of DREI. For instance, a set of DREI with a first set of time stamps may demonstrate operations of the plurality of enterprise applications in the morning and a second set of time stamps may demonstrate operations of the plurality of enterprise applications in the evening. Comparisons of the sets of DREI correct and enhance connections between data exposure found during the first time and the second time. In another embodiment, the set of DREI may be updated based on a triggered action. For instance, if changes are detected within the DREI that deviate from established behavior beyond a predetermined threshold, the set of DREI may be triggered to be updated.

In some embodiments, mapping changes in increase in data exposure in the set of DREI further comprises highlighting components of the set of DREI associated with increased data exposure. For instance, if increased data exposure is determined to be identified in the set of infrastructure within the plurality of enterprise applications, the components of the set of infrastructure may be highlighted. Highlighting components of the set of DREI may comprise transmission of a notification to a predetermined third party, indicating the increased data exposure. In some embodiments, highlighting components of the set of DREI associated with increased data exposure further comprises highlighting within affected components of the set of DREI.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for integrative monitoring of enterprise applications and detection of increased data exposure, the system comprising:
a processing device;
at least one non-transitory storage device; and
at least one processing device coupled to the at least one non-transitory storage device, wherein the at least one processing device is configured to:
monitor, via a machine learning model (MLM), a set of data resiliency exposure indicators (DREI) within a plurality of enterprise applications, a temporal graph associated with the set of DREI, and a set of enterprise application measurement data, for data exposure within the plurality of enterprise applications;
perform temporal graph analysis of the temporal graph associated with the set of DREI via the MLM;
detect increases in data exposure within the set of DREI, the temporal graph associated with the set of DREI, and the set of enterprise application measurement data via the MLM,
wherein detecting increases in data exposure within the set of DREI are found within relationships between components of the set of DREI; and
map changes of increases in data exposure within the plurality of enterprise applications.

2. The system of claim 1, wherein the at least one processing device is further configured to predict potential data exposure within the plurality of enterprise applications via event-based clustering, wherein event-based clustering highlights potential data exposure.

3. The system of claim 1, wherein the set of DREI comprises a set of time stamps.

4. The system of claim 3, wherein the set of DREI within the plurality of enterprise applications is updated in predetermined intervals.

5. The system of claim 1, wherein mapping changes in increase in data exposure in the set of DREI further comprises highlighting components of the set of DREI associated with increased data exposure.

6. The system of claim 1, wherein the temporal graph associated with the set of DREI may comprise telemetry data and metadata associated with the plurality of enterprise applications metadata.

7. The system of claim 1, wherein the set of DREI comprises a set of infrastructure, enterprise application processes, service metrics, and enterprise application data.

8. A computer program product for integrative monitoring of enterprise applications and detection of increased data exposure, the computer program product comprising at least one non-transitory computer-readable medium having computer-readable program code portions embodied therein, the computer-readable program code portions which when executed by a processing device are configured to cause a processor to perform the following operations:
monitor, via a machine learning model (MLM), a set of data resiliency exposure indicators (DREI) within a plurality of enterprise applications, a temporal graph associated with the set of DREI, and a set of enterprise application measurement data, for data exposure within the plurality of enterprise applications;
perform temporal graph analysis of the temporal graph associated with the set of DREI via the MLM;
detect increases in data exposure within the set of DREI, the temporal graph associated with the set of DREI, and the set of enterprise application measurement data via the MLM,
wherein detecting increases in data exposure within the set of DREI are found within relationships between components of the set of DREI; and
map changes of increases in data exposure in plurality of enterprise applications.

9. The computer program product of claim 8, wherein the processor is further configured to predict potential data exposure via event-based clustering, wherein event-based clustering highlights potential data exposure.

10. The computer program product of claim 8, wherein the set of DREI comprises a set of time stamps.

11. The computer program product of claim 10, wherein the set of DREI within the plurality of enterprise applications is updated in predetermined intervals.

12. The computer program product of claim 8, wherein mapping changes in increase in data exposure in the set of DREI further comprises highlighting components of the set of DREI associated with increased data exposure.

13. The computer program product of claim 8, wherein the temporal graph associated with the set of DREI may comprise telemetry data and metadata associated with the plurality of enterprise applications metadata.

14. The computer program product of claim 8, wherein the set of DREI comprises a set of infrastructure, enterprise application processes, service metrics, and enterprise application data.

15. A computer-implemented method for integrative monitoring of enterprise applications and detection of increased data exposure, the method comprising:
monitoring, via a machine learning model (MLM), a set of data resiliency exposure indicators (DREI) within a plurality of enterprise applications, a temporal graph associated with the set of DREI, and a set of enterprise application measurement data, for data exposure within the plurality of enterprise applications;
performing temporal graph analysis of the temporal graph associated with the set of DREI via the MLM;
detecting increases in data exposure within the set of DREI, the temporal graph associated with the set of DREI, and the set of enterprise application measurement data via the MLM,
wherein detecting increases in data exposure within the set of DREI are found within relationships between components of the set of DREI; and
mapping changes of increases in data exposure within the plurality of enterprise applications.

16. The computer-implemented method of claim 15, wherein the method further comprises predicting potential data exposure via event-based clustering, wherein event-based clustering highlights potential data exposure.

17. The computer-implemented method of claim 15, wherein the set of DREI comprises a set of time stamps.

18. The computer-implemented method of claim 17, wherein the set of DREI within the plurality of enterprise applications is updated in predetermined intervals.

19. The computer-implemented method of claim 15, wherein mapping changes in increase in data exposure in the set of DREI further comprises highlighting components of the set of DREI associated with increased data exposure.

20. The computer-implemented method of claim 15, wherein the set of DREI comprises a set of infrastructure, enterprise application processes, service metrics, and enterprise application data.
